(19) United States
(12) Patent Application Publication
(10) Pub. No.: US 2021/0073256 A1
(43) Pub. Date: Mar. 11, 2021

(54) ELECTRONIC DEVICE, ONLINE DOCUMENT-BASED CRIME TYPE DETERMINATION METHOD, AND RECORDING MEDIUM

(71) Applicant: ELECTRONICS AND TELECOMMUNICATIONS RESEARCH INSTITUTE, Daejeon (KR)

(72) Inventor: Won Joo PARK, Daejeon (KR)

(21) Appl. No.: 16/817,992

(22) Filed: Mar. 13, 2020

(30) Foreign Application Priority Data
Sep. 10, 2019 (KR) 10-2019-0112494

(51) Int. Cl. G06F 16/35; G06F 16/31; G06F 16/383

(52) U.S. Cl. CPC G06F 16/353; G06Q 50/26; G06F 16/383; G06F 16/328

(57) ABSTRACT

An electronic device includes: a communication circuit that communicates with an electronic device; a memory which stores crime term dictionary information and at least one instruction; and a processor functionally connected to the communication circuit and the memory, wherein the processor executes the at least one instruction to: collect crime-related documents from the external electronic device during a first period through the communication circuit; extract crime-related words included in the crime-related documents on the basis of the crime term dictionary information; group the crime-related words on the basis of a designated online non-parametric topic modeling technique to generate topic sets; identify crime types each corresponding to one of the topic sets; and map the crime types to the topic sets and store the topic sets mapped to the crime types in the memory in association with the first period.

### CROSS-REFERENCE TO RELATED APPLICATION

This application claims priority to and the benefit of Korean Patent Application No. 10-2019-0112494, filed on Sep. 10, 2019, the disclosure of which is incorporated herein by reference in its entirety.

### BACKGROUND

### 1. Field of the Invention

Embodiments of the present disclosure relate to a topic modeling technology.

### 2. Description of Related Art

With the acceleration of social change, crimes are becoming more diversified and intelligent. Crime analysis relies on manual tasks carried out by experts (humans) and thus requires a lot of time and effort.

Meanwhile, as media services (e.g., news) or public services (e.g., services of information agencies) become digitized, text resources describing crime activities are becoming abundant. In addition, there is increasing research on a technique for identifying the topic of a document on the basis of words included in the document.

### SUMMARY OF THE INVENTION

The present disclosure provides an electronic device, an online document-based crime type determination method, and a recording medium, which are capable of detecting a type of new offense by learning criminal activity related documents on the basis of artificial intelligence technology.

The technical objectives of the present disclosure are not limited to the above, and other objectives may become apparent to those of ordinary skill in the art based on the following description.

According to one aspect of the present disclosure, there is provided an electronic device including a communication circuit that communicates with an external electronic device, a memory in which crime term dictionary information and at least one instruction are stored, and a processor functionally connected to the communication circuit and the memory, wherein the processor executes the at least one instruction to collect crime-related documents from the external electronic device during a first period through the communication circuit, primarily extract a plurality of crime-related words included in the crime-related documents on the basis of the crime term dictionary information, group the plurality of primarily extracted crime-related words on the basis of a designated online non-parametric topic modeling technique so as to primarily generate a plurality of topic sets, primarily identify crime types each corresponding to one of the plurality of primarily generated topic sets, and map the primarily identified crime types to the plurality of primarily generated topic sets and store the plurality of primarily generated topic sets mapped to the primarily identified crime types in the memory in association with the first period

According to one aspect of the present disclosure, there is provided a method of determining a crime type on the basis of crime-related documents by an electronic device, the method including collecting crime-related documents from an external electronic device during a first period, extracting a plurality of crime-related words included in the crime-related documents on the basis of designated crime term dictionary information, grouping the plurality of extracted crime-related words on the basis of a designated online non-parametric topic modeling technique so as to generate a plurality of topic sets, identifying crime types corresponding to the plurality of generated topic sets, and mapping the identified crime types to the plurality of generated topic sets and storing the plurality of generated topic sets mapped to the identified crime types in a memory in association with the first period.

According to one aspect of the present disclosure, there is provided a computer readable recording medium including a program for executing a method of determining a crime type is stored, wherein the method includes collecting crime-related documents generated during a first period from an external electronic device, extracting a plurality of crime-related words included in the crime-related documents on the basis of designated crime term dictionary information, grouping the plurality of extracted crime-related words on the basis of a designated online non-parametric topic modeling technique so as to generate a plurality of topic sets, identifying crime types each corresponding to one of the plurality of generated topic sets, and mapping the crime types to the plurality of topic sets and storing the plurality of topic sets mapped to the crime types in a memory in association with the first period.

### BRIEF DESCRIPTION OF THE DRAWINGS

FIG. 1 is a block diagram illustrating an electronic device according to an embodiment.

FIGS. 2A and 2B is a diagram illustrating a process of updating topic sets according to an embodiment.

FIG. 3 is a flowchart showing a method of determining a crime type according to an embodiment.

FIG. 4 is a flowchart showing a method of identifying a new crime type and an absent crime type according to an embodiment.

FIG. 5 is an example of a graph showing a change of a topic model over time according to an embodiment.

FIG. 6 is another example of a graph showing a change of a topic model over time according to an embodiment.

FIGS. 7A and 7B illustrate examples of determination of crime types according to an embodiment.

FIGS. 8A and 8B illustrates a graph showing a change of crime types over time according to an embodiment.

In connection with the description of the drawings, the same or similar reference numerals may be used for the same or similar components.

### DETAILED DESCRIPTION OF EXEMPLARY EMBODIMENTS

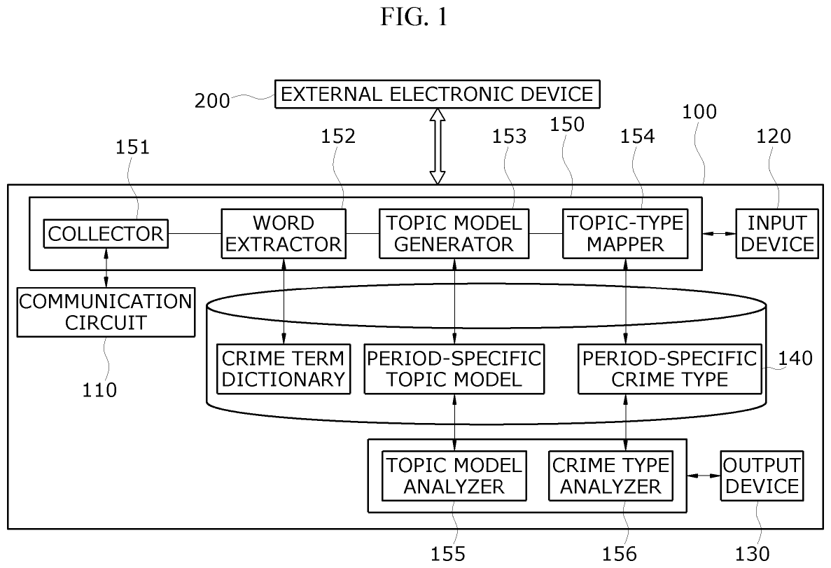

FIG. 1 is a block diagram illustrating an electronic device according to an embodiment.

Referring to FIG. 1, an electronic device 100 according to the embodiment may include a communication circuit 110, an input device 120, an output device 130, a memory 140, and a processor 150. In an embodiment, some components may be omitted from or added to the electronic device 100. In addition, some of the components of the electronic device 100 may be combined into a single component while performing the functions thereof before the combination. In one embodiment, the electronic device 100 may include at least one of a personal computer (PC), a notebook PC, a smart phone, a tablet PC, and a web server.

The communication circuit 110 may support establishment of a communication channel or wireless communication channel between the electronic device 100 and another device (for example, an external electronic device 200), and support communication through the established communication channel. The communication channel may be, for example, a communication channel of various communication methods, such as a local area network (LAN), a fiber to the home (FTTH), an x-digital subscriber line (xDSL), wireless-fidelity (WiFi), wireless broadband (WiBro), 3G, or 4G.

The input device 120 may detect or receive a user input. For example, the input device 120 may include at least one of a touch sensor, a touch pad, a keyboard, and a mouse.

The output device 130 may be a device capable of outputting at least one of a sound and an image. For example, the output device 130 may include at least one of a speaker for outputting a sound or a display for outputting an image.

The memory 140 may store various pieces of data used by at least one component (for example, the processor 150) of the electronic device 100. The data may include, for example, input data or output data regarding software and commands associated with the software. The data may include instructions for a designated non-parametric topic modeling. For example, the data may include a crime term dictionary (a criminal term dictionary database (DB)) including a plurality of terms used for description of a criminal activity or a plurality of pieces of term information (e.g., a binary code corresponding to the term). For example, the memory 140 may store at least one instruction for collecting crime-related documents from the external electronic device 100 during a first period through the communication circuit 110, extracting a plurality of crime-related words included in the crime-related documents on the basis of the crime term dictionary information, group the plurality of extracted crime-related words on the basis of a designated online non-parametric topic modeling technique so as to generate a plurality of topic sets, identifying crime types each corresponding to one of the plurality of topic sets, and mapping the crime types to the plurality of topic sets so as to be associated with the first period. The memory 140 may include a volatile memory or a nonvolatile memory. The processor 150 may control at least one another component (e.g., a hardware or software component) of the electronic device 100 and may perform various types of data processing or operations. The processor 150 may include, for example, a central processing unit (CPU), a graphics processing unit (GPU), a microprocessor, an application processor, an application specific integrated circuit (ASIC), and field programmable gate arrays (FPGAs), and may have a plurality of cores.

The processor 150 includes a collector 151, a word extractor 152, a topic model generator 153, a topic-type mapper 154, a topic model analyzer 155, and a crime type analyzer 156. Each of the components 151, 152, 153, 154, 155, and 156 of the processor 150 may be a separate hardware module or a software module implemented by at least one processor 150. For example, functions performed by the respective modules included in the processor 150 may be performed by one processor or separate processors.

According to an embodiment, the collector 151 may collect crime-related documents from the external electronic device 200 through the communication circuit 110. The crime-related documents may include various documents related to a criminal activity (e.g., an online document or an electronic document). The crime-related documents may include, for example, at least one of online news, a press release of a government agency, and a report of investigation of a government agency. The collector 151 may generate or download the crime-related documents including text describing crime activities by accessing a designated domain. The external electronic device 200 may include, for example, at least one of a server of a news agency and a server of a government agency (e.g., a police agency, a fire agency, or a prosecutor's office) that may provide crime-related documents online. When the collector 151 collects the crime-related documents, the collected crime-related documents may be stored in the memory 140 to be associated (e.g., tagging) with unit time. For example, the collector 151 may group crime-related documents associated with the same unit time and store the group of crime-related documents in the memory 140. The unit time may include, for example, at least one of a year (or another unit period) in which the crime-related document was collected and a year (or another unit period) in which the crime-related documents were published (or were generated).

According to an embodiment, the word extractor 152 may extract crime-related words from a set (or group) of crime-related documents on the basis of a crime term dictionary. For example, the word extractor 152 may extract at least one word of a noun, a verb, and an adjective that may be included in the crime term dictionary or having a similarity to a word included in the crime term dictionary (e.g., at least one word of a noun, a verb, and an adjective-having a feature vector that is similar to a feature vector of a word included in the crime term dictionary at a similarity greater than or equal to a designated similarity).

According to an embodiment, the topic model generator 153 may group the plurality of crime-related words on the basis of a designated online non-parametric topic modeling technique to generate a plurality of topic sets. The topic modeling is one of data mining techniques and may be a probabilistic model algorithm that extracts a meaningful topic from a bunch of unstructured text data. The topic may be a probability distribution of words. The designated online non-parametric topic modeling technique is a topic modeling technique in which the number of topics to be extracted is not determined and may include, for example, a hierarchical Dirichlet process (HDP). For example, the topic model generator 153 may exclude generalized crime-related words that are considered unusable due to commonly appearing in all the extracted crime-related documents. The topic model generator 153 may perform the topic modeling by assigning a higher weight to a word that has a low redundancy with other topics among the extracted crime-related words and enables a unique feature of each topic to be identified. As another example, the topic model generator 153 may perform the topic modeling on the basis of co-occurrence of crime-related words in the respective crime-related documents. Additionally, the plurality of topic sets may include crime-related words included in each topic set and probability distributions for the crime-related words. Also, the plurality of topic sets may be associated with the weight of each crime-related word and a unique identifier (e.g., t1) of each topic.

According to an embodiment, the topic model generator 153 groups crime-related words included in a crime-related document set by each unit period to generate a plurality of topic sets by each unit period. The topic model generator 153 may associate (e.g., tagging) the topic sets by each unit period with the unit time and store the topic sets in the memory 140. The plurality of topic sets may be determined on the basis of the degree of co-occurrence and the distance proximity of words included in each topic set. For example, words having a high degree of co-occurrence and a high distance proximity (e.g., a degree of co-occurrence higher than or equal to a first threshold and a distance proximity hither than or equal to a second threshold) may belong to the same topic set.

According to an embodiment, the topic model generator 153 may update the crime term dictionary stored in the memory 140 on the basis of the topic sets. For example, the topic model generator 153 may allow at least one of crime-related words that appear (or are included) more than a specified number of times and crime-related words that have a weight greater than or equal to a designated weight among the crime-related words included in the topic sets to be included in the crime term dictionary.

According to an embodiment, the topic model generator 153 may generate topic sets (or perform topic model learning) of the current unit period on the basis of the designated online non-parametric topic modeling technique and topic sets of a previous unit period. For example, the topic model generator 153 may generate topic sets of a first period (topic sets associated with a first period) according to the above described method. Thereafter, the topic model generator 153 may group crime-related words associated with a second period subsequent to the first period on the basis of the designated non-parametric topic modeling technique and the topic sets associated with the first period so as to generate topic sets of the first period.

The topic model generator 153 may synthesize topic sets of a first period and topic sets of a second period and use the synthesized topic sets when performing topic modeling for a third period subsequent to the second period. For example, the topic model generator 153 combines the topic sets of the first period and the topic sets of the second period such that at least one of: at least one topic set among the topic sets of the second period that overlaps the topic sets of the first period; and a probability distribution of crime-related words, among crime-related words included in the topic sets of the second period, which are included in the topic sets of the first period. In addition, the topic model generator 153 may generate topic sets corresponding to crime-related documents collected during the third period on the basis of the designated online non-parametric topic modeling technique and the topic sets synthesized as described above. As such, the topic model generator 153 performs topic model learning on the basis of infinite word resources (crime-related documents published on the web), and as the topic modeling is repeated for crime-related documents, changes of topic sets (e.g., change in the weight of a topic, generation of a topic, and disappearance of a topic) may be identified.

According to an embodiment, the topic-type mapper 154 may identify crime types corresponding to topic sets by each unit period. For example, the topic model generator 153 may output topic sets by each unit period through the output device 130. The topic model generator 153 may output a user interface that displays topic sets by each unit period and allows crime types mapped to the topic sets to be input (or be set). The topic model generator 153 may identify crime types (e.g., text indicating a crime type) corresponding to the respective topic sets which are input by the input device 120 through the output user interface. The topic-type mapper 154 may map the identified crime types to the topic sets and store the identified crime types mapped to the topic sets in the memory 140 in association with the unit period.

According to an embodiment, the topic model analyzer 155 may identify a change of topic sets over time on the basis of a plurality of topic sets by each unit time. The topic model analyzer 155 may generate a graph image for representing the identified change of topic sets over time and display the generated graph image through the output device 130. For example, the topic model analyzer 155 may identify the weight of each topic set (or the weight of each topic) by each unit period and generate a graph image that represents a change of weight ratios of the topics. For another example, the topic model analyzer 155 may generate a graph image that represents a generated topic set or an absent topic set among the plurality of topic sets.

According to an embodiment, the crime type analyzer 156 may identify a crime type mapped to each topic set and may identify a change of the crime types over time. The crime type analyzer 156 may generate a graph image capable of representing a change of the crime types over time and display the generated graph image through the output device 130. For example, the crime type analyzer 156 may determine the weight of each topic (the weight of each topic set) for each unit period as a proportion of the crime type. The weight of the topic may be determined according to the frequency of occurrence of words included in each topic set. The higher the frequency of occurrence of words in each topic set, the higher the weight of the topic. The sum of the weights of all topics is one and the weight of each topic may be a decimal smaller than or equal to one. The crime type analyzer 156 may generate a graph image distinctively representing the proportions of the determined crime types and representing the crime type mapped to each topic set.

According to an embodiment, the crime type analyzer 156 may determine at least one crime type included in the next unit period without being included in the previous unit period as a new crime type (a type of new offense). The crime type analyzer 156 may determine at least one crime type included in the previous unit period without being included in the next unit period as an absent crime type. The crime type analyzer 156 may output information (e.g., text) about the new crime type or the absent crime type through the output device 130.

According to various embodiments, the word extractor 152 may use different crime term dictionaries according to the type of crime-related documents. For example, the crime-related documents may include a first type of crime-related documents collected by the police agency and a second type of crime-related documents collected by the news agency. In this case, the word extractor 152 uses a first crime term dictionary related to criminal terms commonly used by the police agency when extracting crime-related words included in the first type of crime-related documents and uses a second crime term dictionary related to criminal terms commonly used by the news agency when extracting crime-related words included in the second type of crime-related documents.

According to various embodiments, when the proportion of a topic set changes more than a specific ratio over time, the electronic device 100 determines the topic set to be a crime type having a possibility of becoming absent and outputs the determined crime type having a possibility of becoming absent through the output device 130.

According to various embodiments, the electronic device 100 may collect event related documents, extract event related words included in the collected event related documents on the basis of event term information, generate an event model on the basis of the extracted event related words, and determine an event type corresponding to the event model.

According to the above-described embodiment, the electronic device 100 may classify the crime types (or event types) on the basis of unsupervised learning and analyze and visualize the appearance of the new crime type or the change trend of the crime type. Therefore, the time and effort of a user (an expert) who desires to identify the crime type by analyzing criminal records or the news one by one may be reduced.

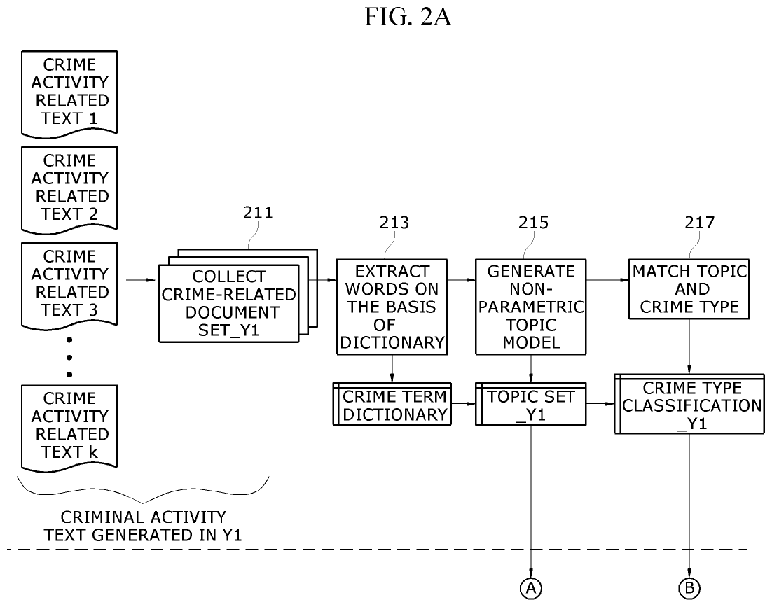

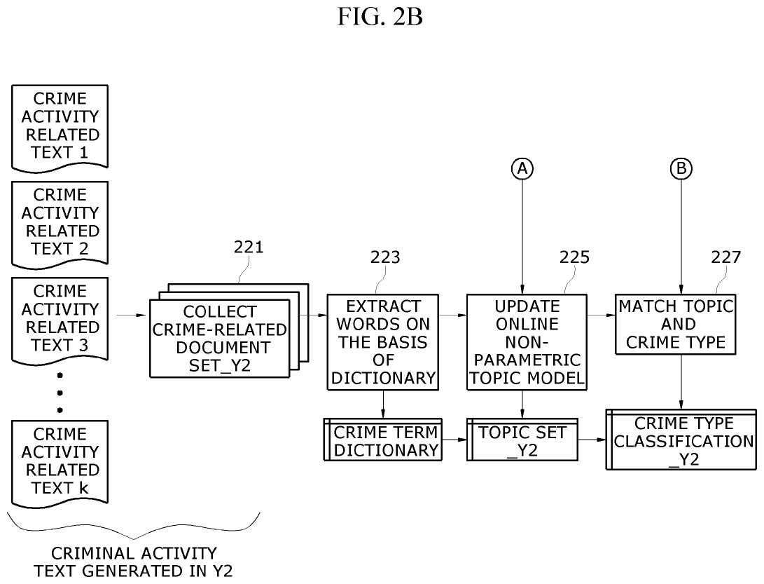

FIGS. 2A and 2B is a diagram illustrating a process of updating topic sets according to an embodiment.

Referring to FIGS. 2A and 2B, the electronic device 100 may collect crime-related documents from the external electronic device 200 during a first period (year Y1) (211). The electronic device 100 may extract a plurality of crime-related words included in the crime-related documents of the first period on the basis of a crime term dictionary (213). The electronic device 100 may group the plurality of crime-related words of the first period on the basis of a designated online non-parametric topic modeling technique to generate a plurality of topic sets (topic model_Y1) and associate the plurality of generated topic sets (topic model_Y1) with the first period (215). The electronic device 100 may identify crime types corresponding to the plurality of topic sets of the first period (217). The electronic device 100 may map information of the identified crime types (crime type classification_Y1) to the plurality of topic sets of the first period and store the information of the identified crime types mapped to the plurality of topic sets in the memory 140 in association with the first period.

The electronic device 100 may collect crime-related documents from the external electronic device 200 during a second period (year Y2) (221). The electronic device 100 may extract a plurality of crime-related words included in the crime-related documents of the second period on the basis of the crime term dictionary that is expanded during the second period (223). The electronic device 100 may perform online learning on the plurality of crime-related words of the second period on the basis of the designated online non-parametric topic modeling technique and the topic sets (topic model_Y1) associated with the first period so as to generate a plurality of topic sets (topic model_Y2) associated with the second period (225). The electronic device 100 may associate the plurality of generated topic sets (topic model_Y2) with the second period. The electronic device 100 may identify crime types corresponding to the plurality of topic sets of the second period (227). The electronic device 100 may map the identified crime types (crime type classification_Y2) to the plurality of topic sets of the second period and store the identified crime types mapped to the plurality of topic sets in the memory 140 in association with the second period.

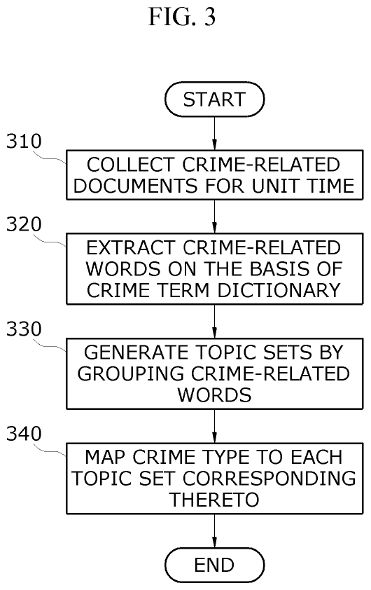

FIG. 3 is a flowchart showing a method of determining a crime type according to an embodiment.

Referring to FIG. 3, the electronic device 100 may collect crime-related documents from the external electronic device 200 on a unit period basis (310). The crime-related document may include, for example, at least one of online news, a press release of a government agency, and a report of investigation of a government agency.

The electronic device 100 may extract a plurality of crime-related words included in the crime-related documents of each unit period on the basis of a crime term dictionary (320). The crime term dictionary may include, for example, a plurality of terms used for the description of a criminal activity or term information (e.g., a binary code corresponding to a term).

The electronic device 100 may group the plurality of crime-related words by each unit period on the basis of a designated online non-parametric topic modeling technique to generate a plurality of topic sets (330). For example, the electronic device 100 may perform topic modeling on the basis of co-occurrence of crime-related words in the respective crime related documents. The electronic device 100 may associate the plurality of generated topic sets with the unit period and store the generated topic sets.

The electronic device 100 may map each of the plurality of topic sets by each unit period to a crime type corresponding to each topic set and store the plurality of topic sets mapped to the crime types in the memory 140 (340). For example, the electronic device 100 may output a user interface capable of receiving input of crime types corresponding to topic sets by each unit period through the output device 130, identify crime types input through the user interface, and map the identified crime types to the topic sets.

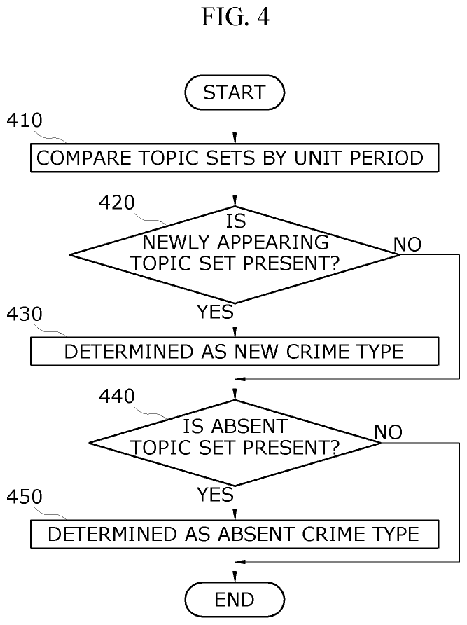

FIG. 4 is a flowchart showing a method of identifying a new crime type and an absent crime type according to an embodiment.

Referring to FIG. 4, the electronic device 100 may compare topic sets of a previous unit period with topic sets of a current unit period (410). For example, the electronic device 100 may identify at least one of the presence/absence of the topic set of the previous unit period and change of a proportion of the topic set of the previous unit period.

The electronic device 100 may identify whether a topic set newly appearing in the current unit period is present (420). For example, the electronic device 100 may identify whether there is a topic set (a newly appearing topic set) included in the current unit period without being included in the previous unit period.

The electronic device 100 may determine that the newly appearing topic set is a topic set corresponding to a new crime type (430). The electronic device 100 may output the topic set corresponding to the new crime type through the output device 130, identify the new crime type on the basis of a user's input regarding the output topic set, map the identified new crime type to the topic set.

The electronic device 100 may identify whether there is a topic set absent in the current unit period (440). For example, the electronic device 100 may identify whether there is a topic set (an absent topic set) included in the previous unit period without being included in the current unit period.

The electronic device 100 may determine that the absent topic set is a topic set corresponding to an absent crime type (450).

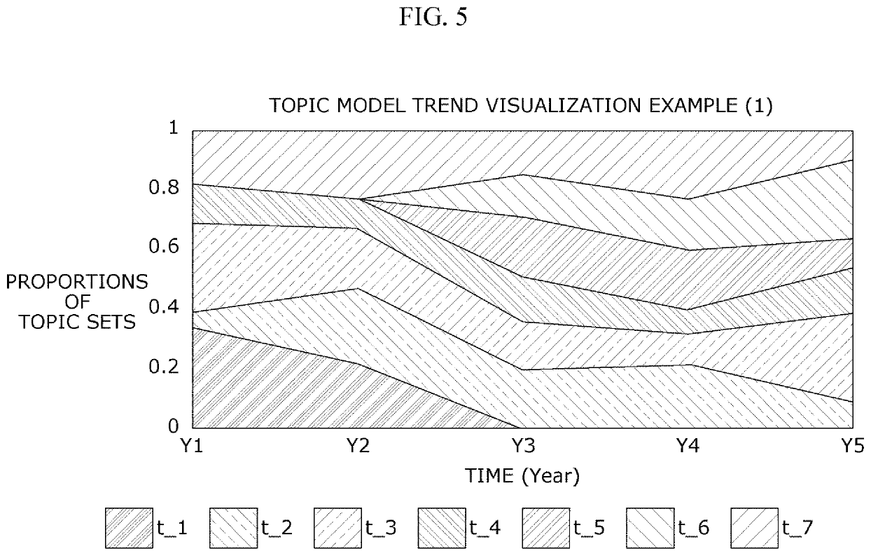

FIG. 5 is an example of a graph showing a change of a topic model over time according to an embodiment. In the graph of FIG. 5, the horizontal axis may be an axis representing unit periods (Y1, Y2, Y3, Y4, and Y5) and the vertical axis may be an axis representing the proportions of individual topic sets.

Referring to FIG. 5, the electronic device 100 may generate a graph image that represents the respective topic sets in different specified colors (or patterns) and represents the weight proportions of the respective topic sets by each unit period as the areas occupied by the specified colors on each vertical axis and may output the generated graph image through the output device 130. When the topic sets are updated by each unit period, under the assumption that the change of the topic sets over the unit periods is linear, the areas occupied by the specified colors are linearly changed over the unit periods.

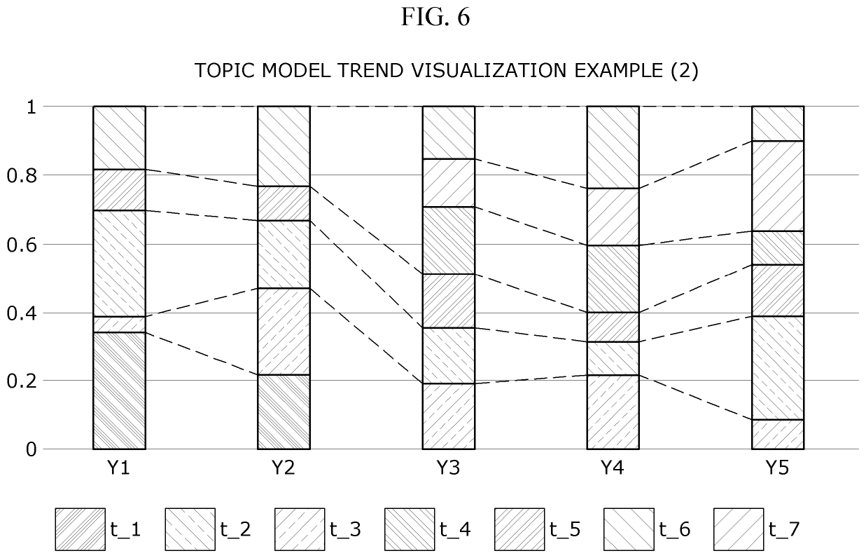

FIG. 6 is another example of a graph showing a change of a topic model over time according to an embodiment. The horizontal axis of FIG. 6 represents unit period and the vertical axis represents the proportion of each topic set.

Referring to FIG. 6, the electronic device 100 may generate, on vertical axes of the respective unit periods Y1, Y2, Y3, Y4, or Y5, bar graph images in which the proportion of each topic set with respect to all crime-related words of each unit period is represented as the area occupied by a specified color. The electronic device 100 may output the generated bar graph images through the output device 130. In the bar graph image, the individual topic sets may be distinctively displayed in different specified colors (or patterns).

According to the above-described embodiment, the electronic device 100 may generate and output a graph for representing the trend of topic set change over time on the basis of crime-related documents so that the user is supported to easily identify a change of topic sets or crime types.

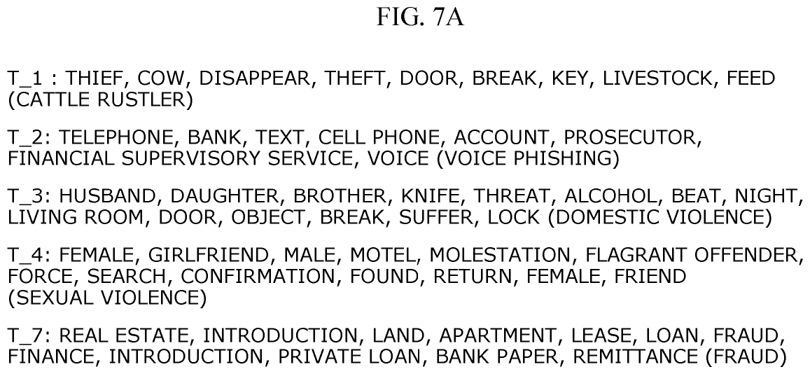

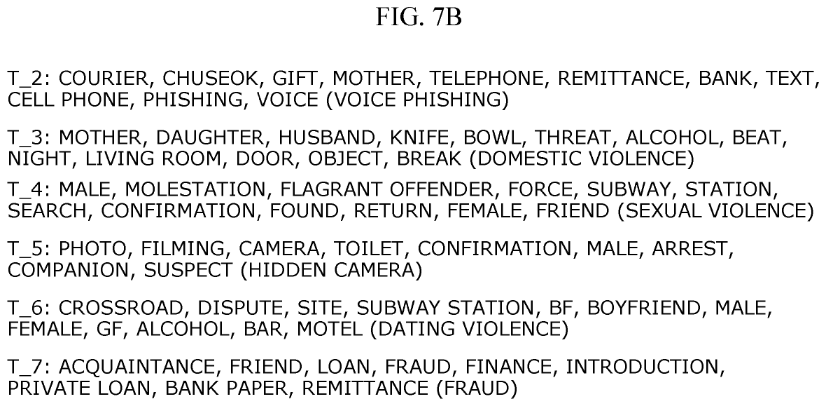

FIGS. 7A and 7B illustrate examples of determination of crime types according to an embodiment. FIGS. 7A and 7B may illustrate the topic sets and crime types of the unit periods of Y2 and Y3 shown in FIGS. 5 and 6.

Referring to FIG. 7A, the electronic device 100 may generate five topic sets t_1, t_2, t_3, t_4 and t_7 by grouping crime-related words extracted from crime-related documents during the first period. The topic set t_1 may include crime-related words, such as “thief”, “cow”, “disappear”, “theft”, “door”, “break”, “key”, “livestock” and “feed”. The topic set t_2 may include crime-related words, such as “telephone”, “bank”, “text”, “cell phone”, “account”, “prosecutor”, “financial supervisory service”, and “voice”. The topic set t_3 may include crime-related words, such as “husband”, “daughter”, “brother”, “knife”, “threat”, “alcohol”, “beat”, “night”, “living room”, “door”, “object”, “break”, “suffer”, and “lock”. The topic set t_4 may include crime-related words, such as “female”, “GF”, “male”, “motel”, “molestation”, “flagrant offender”, “force”, “search”, “confirmation”, “found”, “return”, “female”, and “friend”. The topic set t_7 may include crime-related words, such as “real estate”, “introduction”, “land”, “apartment”, “lease”, “loan”, “fraud”, “finance”, “introduction”, “private loan”, “bank paper” and “remittance”. The electronic device 100, in response to identification (e.g., input) of a plurality of crime types (cattle rustling, voice phishing, domestic violence, sexual violence, and fraud, displayed in parenthesis next to the respective topic sets in FIG. 7A) corresponding to the five topic sets t_1, t_2, t_3, t_4, and t_7, may map the plurality of crime types (cattle rustling, voice phishing, domestic violence, sexual violence, and fraud) to the plurality of topic sets t_1, t_2, t_3, t_4, and t_7, respectively, and store the plurality of topic sets t_1, t_2, t_3, t_4, and t_7 mapped to the crime types.

Referring to FIG. 7B, the electronic device 100 may generate six topic sets t_2, t_3, t_4, t_5, t_6 and t_7 by grouping crime-related words extracted from crime-related documents during the second period. The topic set t_2 may include crime-related words, such as “courier”, “chuseok”, “gift”, “mother”, “telephone”, “remittance”, “bank”, “text”, “cell phone”, “phishing” and “voice”. The topic set t_3 may include crime-related words, such as “mother”, “daughter”, “husband”, “knife”, “bowl”, “threat”, “alcohol”, “beat”, “night”, “living room”, “door”, “object”, and “break”. The topic set t_4 may include crime-related words, such as “male”, “molestation”, “flagrant offender”, “force”, “subway”, “station”, “search”, “confirmation”, “found”, “return”, “female” and “friend”. The topic set t_5 may include crime-related words, such as “photo”, “filming”, “camera”, “toilet”, “confirmation”, “male”, “arrest”, “companion” and “suspect”. The topic set t_6 may include crime-related words, such as “crossroad”, “dispute”, “site”, “subway station”, “BF”, “boyfriend”, “female”, “GF”, “alcohol”, “bar” and “motel”. The topic set t_7 may include crime-related words, such as “acquaintance”, “friend”, “loan”, “fraud”, “finance”, “introduction”, “private loan”, “bank paper”, and “remittance”. The electronic device 100, in response to identification (e.g., input) of a plurality of crime types (voice phishing, domestic violence, sexual violence, hidden camera, dating violence, fraud) corresponding to the six topic sets t_2, t_3, t_4, t_5, t_6, and t_7, may map the plurality of crime types (voice phishing, domestic violence, sexual violence, hidden camera, dating violence, and fraud) to the plurality of topic sets t_2, t_3, t_4, t_5, t_6, and t_7, respectively, and store the plurality of topic sets t_2, t_3, t_4, t_5, t_6, and t_7, mapped to the crime types.

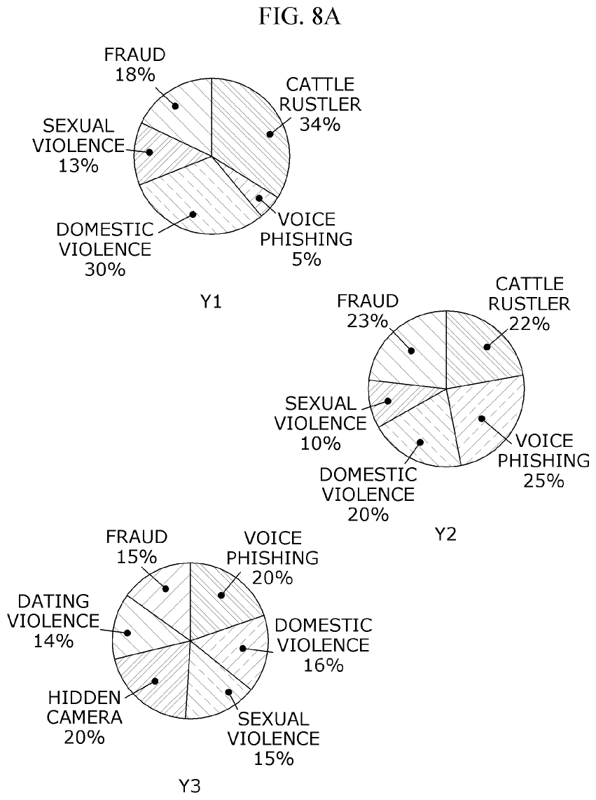

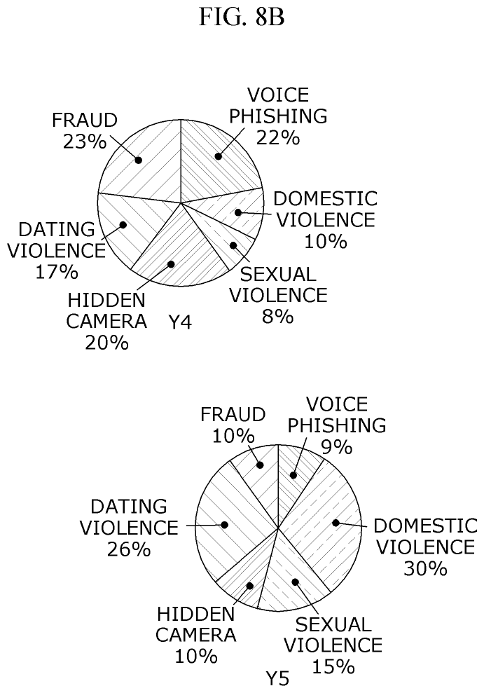

FIGS. 8A and 8B illustrates a graph showing a change of crime types over time according to an embodiment.

Referring to FIGS. 8A and 8B, the electronic device 100 may generate pie graphs each representing proportions of crime types of each unit period obtained on the basis of the weight ratios of topic sets in each unit period and crime types (e.g., crime type text and percentage information) mapped to the individual topic sets. In this process, the electronic device 100 may use the weight of the topic set for each unit period as the proportion of the crime type. The electronic device 100 may display the generated pie graphs through the output device 130.

According to the above-described embodiment, the electronic device 100 may easily represent a change of crime types, a new crime type, or an absent crime type on the basis of crime-related documents.

As is apparent from the above, the electronic device, the online document-based crime type determination method, and the recording medium can detect a new type of crime by learning criminal activity related documents on the basis of artificial intelligence technology. In addition, other advantageous effects directly or indirectly identified through the disclosure can be provided.

The various embodiments of the disclosure and terminology used herein are not intended to limit the technical features of the disclosure to the specific embodiments, but rather should be understood to cover all modifications, equivalents, and alternatives falling within the spirit and scope of the invention. In the description of the drawings, like numbers refer to like elements throughout the description of the drawings. The singular forms preceded by “a,” “an,” and “the” corresponding to an item are intended to include the plural forms as well unless the context clearly indicates otherwise. In the disclosure, a phrase such as “A or B,” “at least one of A and B,” “at least one of A or B,” “A, B or C,” “at least one of A, B and C,” and “at least one of A, B, or C” may include any one of the items listed together in the corresponding phrase of the phrases, or any possible combination thereof. Terms, such as “first,” “second,” etc. are used to distinguish one element from another and do not modify the elements in other aspects (e.g., importance or sequence). When one (e.g., a first) element is referred to as being “coupled” or “connected” to another (e.g., a second) element with or without the term “functionally” or “communicatively,” it means that the one element is connected to the other element directly (e.g., wired), wirelessly, or via a third element.

As used herein, the terms “module” and “unit” may include units implemented in hardware, software, or firmware, and may be interchangeably used with terms, such as logic, logic blocks, components, or circuits. The module may be an integrally configured component or a minimum unit or part of the integrally configured component that performs one or more functions. For example, according to one embodiment, the module may be implemented in the form of an application-specific integrated circuit (ASIC).

The various embodiments of the present disclosure may be realized by software (e.g., a program) including one or more instructions stored in a storage medium (e.g., the memory 140, such as an internal memory or external memory,) that can be read by a machine (e.g., the electronic device 100). For example, a processor (e.g., the processor 150) of the machine (e.g., the electronic device 100) may invoke and execute at least one instruction among the stored one or more instructions from the storage medium. Accordingly, the machine operates to perform at least one function in accordance with the invoked at least one command. The one or more instructions may include code generated by a compiler or code executable by an interpreter. The machine-readable storage medium may be provided in the form of a non-transitory storage medium. Here, when a storage medium is referred to as “non-transitory,” it can be understood that the storage medium is tangible and does not include a signal (for example, electromagnetic waves), but rather that data is semi-permanently or temporarily stored in the storage medium.

According to one embodiment, the methods according to the various embodiments disclosed herein may be provided in a computer program product. The computer program product may be traded between a seller and a buyer as a product. The computer program product may be distributed in the form of a machine-readable storage medium (e.g., compact disc read only memory (CD-ROM)), or may be distributed directly between two user devices (e.g., smartphones) through an application store (e.g., Play Store™), or online (e.g., downloaded or uploaded). In the case of online distribution, at least a portion of the computer program product may be stored at least semi-permanently or may be temporarily generated in a machine-readable storage medium, such as a memory of a server of a manufacturer, a server of an application store, or a relay server.

According to the various embodiments, each of the above-described elements (e.g., a module or a program) may include a singular or plural entity. According to various embodiments, one or more of the above described elements or operations may be omitted, or one or more other elements or operations may be added. Alternatively or additionally, a plurality of elements (e.g., modules or programs) may be integrated into one element. In this case, the integrated element may perform one or more functions of each of the plurality of elements in the same or similar manner as that performed by the corresponding element of the plurality of components before the integration. According to various embodiments, operations performed by a module, program, or other elements may be executed sequentially, in parallel, repeatedly, or heuristically, or one or more of the operations may be executed in a different order, or omitted, or one or more other operations may be added.

What is claimed is:

1. An electronic device comprising:
a communication circuit that communicates with an external electronic device;
a memory in which crime term dictionary information and at least one instruction are stored; and
a processor functionally connected to the communication circuit and the memory, wherein the processor executes the at least one instruction to:
collect crime-related documents from the external electronic device during a first period through the communication circuit;
extract a plurality of crime-related words included in the crime-related documents on the basis of the crime term dictionary information;
group the plurality of extracted crime-related words on the basis of a designated online non-parametric topic modeling technique so as to generate a plurality of topic sets;
identify crime types each corresponding to one of the plurality of topic sets; and
map the crime types to the plurality of topic sets and store the plurality of topic sets mapped to the crime types in the memory in association with the first period.

2. The electronic device of claim 1, wherein the processor extracts at least one of a noun, a verb, and an adjective included in the crime term dictionary information or having a similarity to a word included in the crime term dictionary information from the crime-related documents.

3. The electronic device of claim 1, wherein the processor updates the crime term dictionary information on the basis of the crime-related words having at least one parameter of a frequency and a weight that is relatively high among the plurality of crime-related words.

4. The electronic device of claim 1, wherein the processor is configured to:
collect crime-related documents during a second period subsequent to the first period; and
on the basis of the plurality of topic sets generated during the first period and the crime-related documents collected during the second period, regenerate a plurality of topic sets, repeat the identification of crime types, and perform storing the plurality of topic sets and the identified crime types in association with the second period.

5. The electronic device of claim 4, wherein the processor is configured to:
synthesize the topic sets associated with the first period and the plurality of topic sets associated with the second period; and
use the synthesized topic sets when generating topic sets with respect to crime-related documents generated during a third period subsequent to the second period.

6. The electronic device of claim 4, wherein the processor identifies a change of the crime types over time on the basis of the crime types associated with the first period and the crime types associated with the second period.

7. The electronic device of claim 4, wherein the processor determines the crime type, which is included in the crime types associated with the first period without being included in the crime types associated with the second period, as an absent crime type.

8. The electronic device of claim 4, wherein the processor determines the crime type, which is included in the crime types associated with the second period without being included in the crime types associated with the first period, as a new crime type.

9. The electronic device of claim 4, wherein the processor is configured to:
identify a weight of each of the plurality of regenerated topic sets; and
determine the identified weight as a proportion of the crime type associated with the second period.

10. The electronic device of claim 4, wherein the processor is configured to:
compare the topic sets associated with the first period with the topic sets associated with the second period to generate a first image representing a change of the topic sets over time, and
store the first image in the memory.

11. The electronic device of claim 1, further comprising:
an input device and an output device,
wherein the processor executes the at least one instruction to:
output the plurality of topic sets through the output device; and
identify crime types input through the input device as crime types that are to be mapped to the plurality of topic sets.

12. The electronic device of claim 1, wherein:
the crime-related words included in each of the plurality of topic sets are identified, and
the crime type corresponding to the plurality of topic sets is identified as a broad meaning of the identified crime-related words, or the crime type corresponding to the plurality of topic sets is identified on the basis of a crime type previously mapped to the identified crime related words that is stored in the memory.

13. The electronic device of claim 1, wherein the processor is configured to:
when a plurality of crime types are identified as corresponding to each of the topic sets, identify proportions of the plurality of crime types;
generate an image in which the proportions of the plurality of crime types are distinguished from each other; and
store the generated image in the memory.

14. A method of determining a crime type on the basis of crime-related documents by an electronic device, the method comprising:
collecting crime-related documents generated during a first period from an external electronic device;
extracting a plurality of crime-related words included in the crime-related documents on the basis of designated crime term dictionary information;
grouping the plurality of extracted crime-related words on the basis of a designated online non-parametric topic modeling technique so as to generate a plurality of topic sets;
identifying crime types corresponding to the plurality of generated topic sets; and
mapping the identified crime types to the plurality of generated topic sets and storing the plurality of generated topic sets mapped to the identified crime types in a memory in association with the first period.

15. The method of claim 14, further comprising:
on the basis of the plurality of topic sets generated during the first period and crime-related documents for a second period subsequent to the first period, regenerating a plurality of topic sets, performing the identification of crime types again, and performing storing the plurality of topic sets and the identified crime types in association with the second period.

16. The method of claim 14, further comprising:
identifying a weight of each of the plurality of topic sets; and
determining the identified weight of the topic set as a proportion of the crime type.

17. The method of claim 14, further comprising:
outputting the plurality of topic sets; and
identifying crime types corresponding to the plurality of topic sets which are input by a user.

18. The method of claim 14, further comprising updating the crime term dictionary information on the basis of the crime-related words having at least one parameter of a frequency and a weight that is relatively high among the plurality of crime-related words.

19. A computer readable recording medium including a program for executing a method of determining a crime type is stored, wherein the method comprises:
collecting crime-related documents generated during a first period from an external electronic device;
extracting a plurality of crime-related words included in the crime-related documents on the basis of designated crime term dictionary information;
grouping the plurality of extracted crime-related words on the basis of a designated online non-parametric topic modeling technique so as to generate a plurality of topic sets;
identifying crime types each corresponding to one of the plurality of generated topic sets; and
mapping the crime types to the plurality of topic sets and storing the plurality of topic sets mapped to the crime types in a memory in association with the first period.
